(19) United States
(12) Patent Application Publication
(10) Pub. No.: US 2004/0011961 A1
(43) Pub. Date: Jan. 22, 2004

(54) IR analysis system

(75) Inventors: Alan Graham Platt, Royston (GB); Matthew Thomas Paley, Cambridge (GB)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: THE AUTOMATION PARTNERSHIP (CAMBRIDGE) LTD A British Company of York Way, Royston (GB)

(21) Appl. No.: 10/435,556

(22) Filed: May 12, 2003

(30) Foreign Application Priority Data
Jul. 22, 2002 (EP) 02255098.2

(51) Int. Cl. G01N 21/00

(52) U.S. Cl. 250/339.07

(57) ABSTRACT

An infra-red analysis system is provided for analysing samples disposed in transparent or translucent containers. The system comprises: an infra-red light source; a container locating device for locating a container in a known position relative to the infra-red light source, a spectrometer disposed to receive infra-red light from the containers, means for reading the identity of a container, means for transmitting spectra recorded by the spectrometer to a database, means for recording the spectra and the identity of the container in the database in a record; and means for comparing spectra recorded by the spectrometer with a previously recorded spectrum for the same container.

### BACKGROUND

The present invention relates generally to the analysis of small biological or chemical samples and more particularly to comparisons of the transmission or emission spectra in the Near Infrared to measure the degradation of solutions of compounds stored in microtubes.

In a system where a large number of very small samples are stored over a protracted period there is a risk that some of the samples may degrade over time by the ingress of unwanted impurities such as water. It is beneficial to be able to check whether a sample has been contaminated in a non-intrusive manner.

### BRIEF SUMMARY OF THE INVENTION

According to the present invention there is provided an infra-red analysis system for analysing samples disposed in transparent or translucent containers, the system comprising: an infra-red light source; a container locating device for locating a container in a known position relative to the infra-red light source, a spectrometer disposed to receive infra-red light from the containers, means for reading the identity of a container, means for transmitting spectra recorded by the spectrometer to a database, means for recording the spectra and the identity of the container in the database in a record; and means for comparing spectra recorded by the spectrometer with a previously recorded spectrum for the same container.

Preferably, the container locating device causes the tube to be rotated while maintaining its position relative to the infra-red light source.

The container may be a microtube or a culture plate.

The spectrometer may be disposed to receive light transmitted or reflected by the container.

### BRIEF DESCRIPTION OF THE DRAWINGS

FIG. 1 is a schematic of the apparatus for obtaining the spectra.

FIG. 2 is a screen print showing the spectra of various components that are be found in the microtube 14.

FIG. 3 is a screen print showing a spectrum obtained from an unknown substance that is found to be Dimethyl Sulfoxide (DMSO).

FIG. 4 is a screen print showing a spectrum obtained from DMSO with an impurity imitated by passing the light through a sheet of plastic.

### DETAILED DESCRIPTION

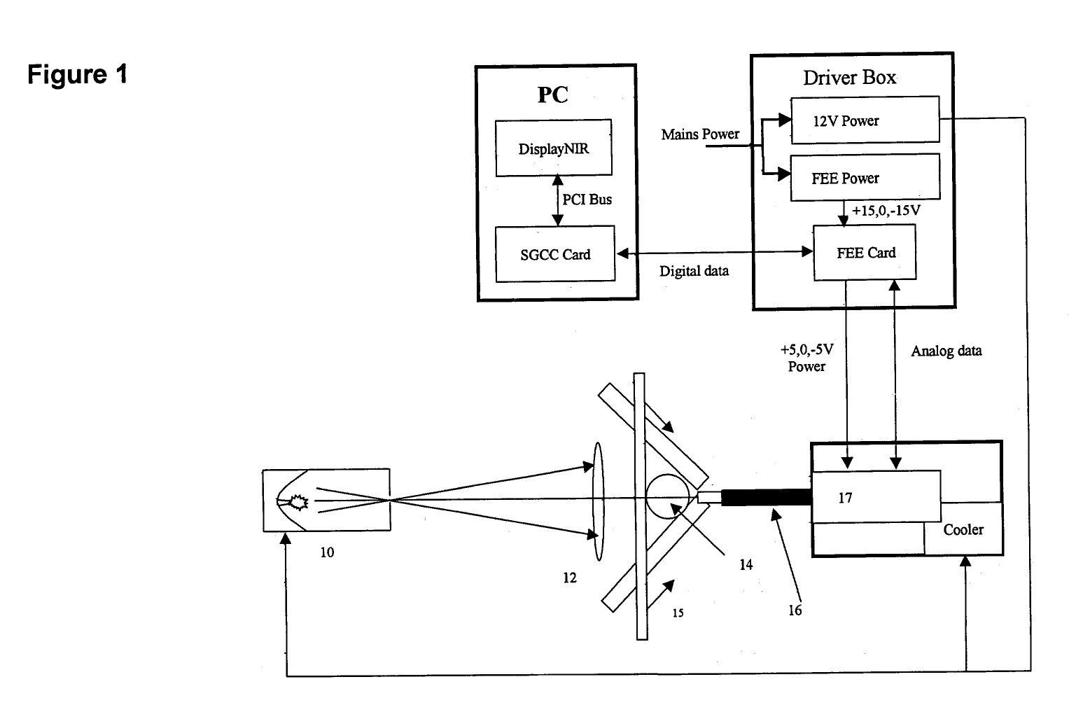

The schematic of FIG. 1 shows a Near Infra-Red (NIR) light source 10, within a lamp enclosure 11. Light leaving the enclosure 11 through an aperture 18 is focussed by a lens 12 on to a sample 13 to be analysed and which is held within a transparent or translucent microtube 14, secured in position by a tube holder 15 which has an optical fibre interface 16 to a spectrometer 17. The fibre optic 16 reduces the effects of refraction and scattering on the data sent to the spectrometer 17.

The microtube 14 may be held in place by a robot which may also spin the microtube 14 whilst maintaining its position relative to the light source 10. This reduces any errors that might occur as a result of imperfections in the fabric of the microtube 14. Alternatively the sample 13 may be held on a culture plate rather than in a microtube 14. This is especially appropriate when the sample 13 comprises living cells that can therefore be tested in situ on the plates in which they are growing. If the spectrum of a biological sample on a culture plate is obtained then it is possible to compare the spectrum at a later date to see whether the plate has been contaminated by products that suggest unprogrammed cell death, or necrosis, has taken place. If this is the case the cells may lyse and release products the spectrum of which can be detected.

The light source 10 is a 12V halogen lamp with an aluminium reflector. Such a lamp has an even light output throughout the NIR wavelengths that are used by the spectrometer 17 and also has the advantage that most of the light will be projected forwards. Projecting the NIR light through the aperture 18 provides a uniform point source of light and allows for collimation of the beam. The use of a lens 12 to focus the light ensures that the light passes into the microtube 13 substantially perpendicular to the walls to minimise the optical path through the walls of the microtube and maximise the path through the contents, this also reduces unwanted lensing effects caused by the curved walls of the microtube. The tube holder 15, in the form of a V-shaped opening with the fibre optic 16 at its tip, allows easy and repeatable positioning of the microtube 14 relative to the light source 10 and fibre optic interface 16. Microtube sample 13 contains a compound which is generally dissolved in DMSO and this solution will absorb a proportion of the NIR radiation. The amount of radiation that is absorbed at each wavelength is dependent on the precise substance that is in the microtube 14, and on the chemical composition of the microtube 14 and the solvent and the radiation transmitted by the tube 14 and contents is detected by the spectrometer 17. The spectrometer 17 allows the amount of radiation that has been absorbed at a number of different wavelengths to be measured giving a chemical signature for the microtube 14 and the sample 13. This signature is stored in a database and can be retrieved at a later date to be compared with a new reading obtained by submitting the same microtube 14 and sample 13 to the tube holder 15 again. Any changes in the readings are attributed to changes in either the microtube 14 or the sample 13. These changes can then be analysed to determine the source of the degradation.

One particular source of degradation of a sample 13 may be the ingress of water into the microtube 14.

An example of a spectrometer that is appropriate is a Zeiss MMS Near Infra-Red spectrometer. The spectrometer uses a 128-element array covering wavelengths from 0.9 μm to 1.7 μm.

The system is calibrated by obtaining white spectra over 20 integration values between 0.8 ms and 51 ms, for all values that are not saturated. Arrays are then built up of the raw count value against the integration time for all 128 wavelengths. Best fits are then calculated on each of these arrays to obtain equations relating the signal value to the integration period for each wavelength. These equations can be used to predict what the white spectrum would be for a given integration time if the detector were immune to saturation. Once the white reference spectrum has been calculated the substance to be measured is put into the system and a set of spectra are taken over the entire range of integration times allowed. The spectrometer 17 produces a vector of 128 integers representing the intensity at different wavelengths at approximately 6 nm increments. To convert these integers into transmissions it is first necessary to know the spectra produced for zero and full transmission. It is then assumed that the spectrometer has a linear response over the range in question and therefore the values can be scaled such that black values go to 0 and unobstructed values go to 1.

The data acquisition is achieved by using two specially designed cards. The output from the spectrometer 17 is in the form of a series of analogue differential voltages which are proportional to the intensity of the light which falls on the internal CCD array during the predefined integration time. The output voltages are converted to a 14-bit digital number on a Front End Electronics card, which is mounted locally to the spectrometer to reduce noise interference on sensitive analogue lines. This digital data is transmitted serially to the Spectrometer Control Card mounted in a remote PC, which in turn transfers the data directly into PC RAM using DMA. These cards also control the digital control and clock signals required by the spectrometer 17. The integration time of the spectrometer 17 can also be controlled from the PC by writing to a register within the card.

Once the data has been collected a number of operations may be performed to determine the contents of the microtube 14. The transmission of light through a substance is subject to exponential decay of the form:

T=e^{klog(t)}

where T is the transmission from k units of substance with a single unit transmission of t. The algorithm works from an observed spectrum and attempts to express it as a combination of reference spectra. The spectrometer records light in 128 different wavelength intervals and therefore all 128 equations must be solved simultaneously. This is done using the Levenberg-Marquardt method. This can be used to find the quantity of each reference spectrum that gives the closest approximation to the observed spectrum. It is possible to measure the change in the quantity of a known substance even if the identity of the substances previously present in the container are not known. This requires that the substances in the container do not change but knowledge of what exactly they are is not necessary. For example given two spectra of the same sample both of which include a fixed degree of absorption from an unknown substance t_{c} it is possible to determine the change in the quantity of a substance with a known spectra t_{b} by analysing the ratio of the spectra. The original spectrum obtained from a container is T₁=t_{c}. A subsequent spectrum from the container is T₂=t_{b}^{*t}_{c}. The ratio T₁/T₂ is t_{b.}

At any stage within this process the data may be displayed in graphical form with either the raw signal count or the transmission on the ordinate and the channel number in the spectrometer 17 on the abscissa. The channel number is related to the wavelength of the light and lower channel numbers correspond to longer wavelengths.

The limitations of the spectrometer's internal CCD array and optics may cause deterioration at each end of the spectrum to the extent that the signal-to-noise ratio could make the data unreliable. To overcome this, if necessary, the first and last few data points for each spectrum may be disregarded.

In order to remove systematic errors within the system it is important to remove the variations due to the dark reference point drifting over time. This is performed by a flat fielding operation, whereby an algorithm is used to combine a dark and a light spectrum to reduce the effects of non-linearities of the spectrometer.

The effects of self lensing around the microtube 14 can also be dealt with without the introduction of specific software by the introduction of a specific spectrum called “grey.nir”. This is a simulated spectrum containing 0% absorption. Lensing causes the entire signal to be multiplied by an unknown value which effectively moves the while level up and down. Providing a uniformly absorbing spectrum allows the algorithm to bring the white level back to 1.0 by multiplying the entire spectrum by a suitable number.

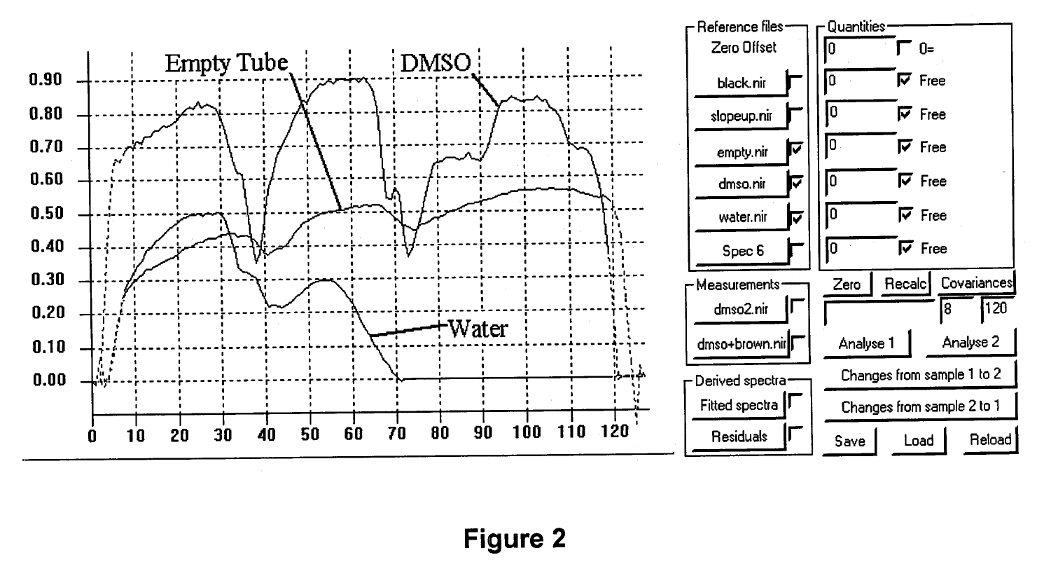

Once these effects have been taken into account the data may be analysed further. The spectrum obtained from a microtube will be made up from a number of components as shown in FIG. 2. NIR will be absorbed in varying quantities by each of the components through which it passes. The spectrum that is obtained from the microtube will thus be reduced by varying amounts by each of the substances present in the mixture including the plastic from which the microtube is formed. The spectrum is analysed to determine which substances are present in the mixture. Firstly the absorption spectrum is calculated from the transmission spectrum. Any known components of the mixture can be measured separately and the data of their spectra can be stored in the database so that suitable comparisons can be made. An algorithm can be used to obtain a best fit line for the unknown contents of the microtube taking into consideration the reference absorption spectra.

The fitting spectra are obtained by multiplying the absorption spectra of the reference samples by a variable representing the proportion of the reference spectra seen. For example if the reference spectra of DMSO was taken through a 3 mm sample the algorithm should produce a “quantity of DMSO present” value of 1.0 for 3 mm and 0.1 for0.3 mm. Where multiple absorption spectra are present the calculated values should be the proportion of that substance present in the sample multiplied by the thickness of the sample and divided by the thickness of the reference sample. If all reference samples are normalised to the thickness of the containers being used the results will give the proportion of each substance in the container.

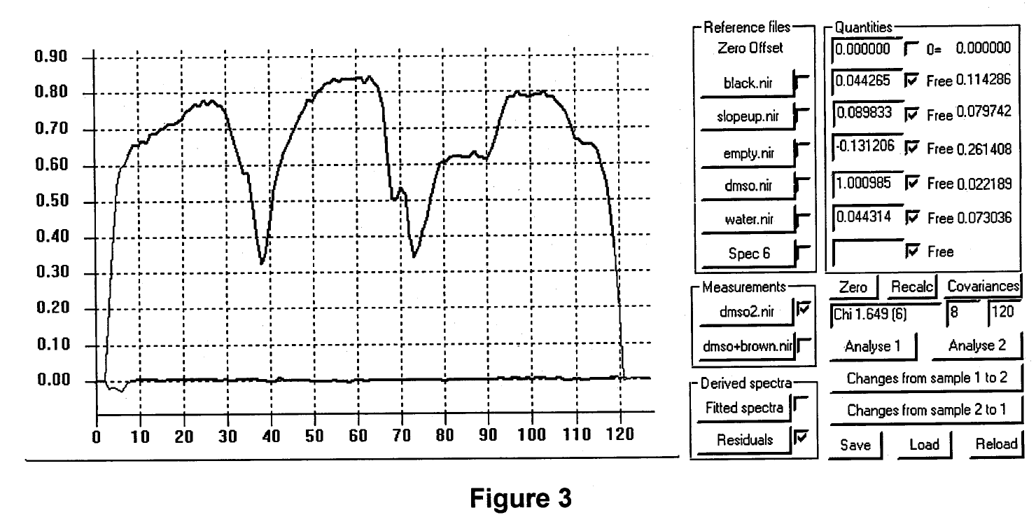

FIG. 3 shows a spectrum obtained from a microtube 14. It is thought to contain DMSO and therefore the spectrum obtained is compared with the reference spectrum for DMSO. The ChiSquared value is low (1.649) which indicates a good correlation between the substance in the microtube and the reference spectrum for DMSO. It is therefore possible to deduce that the microtube contains DMSO.

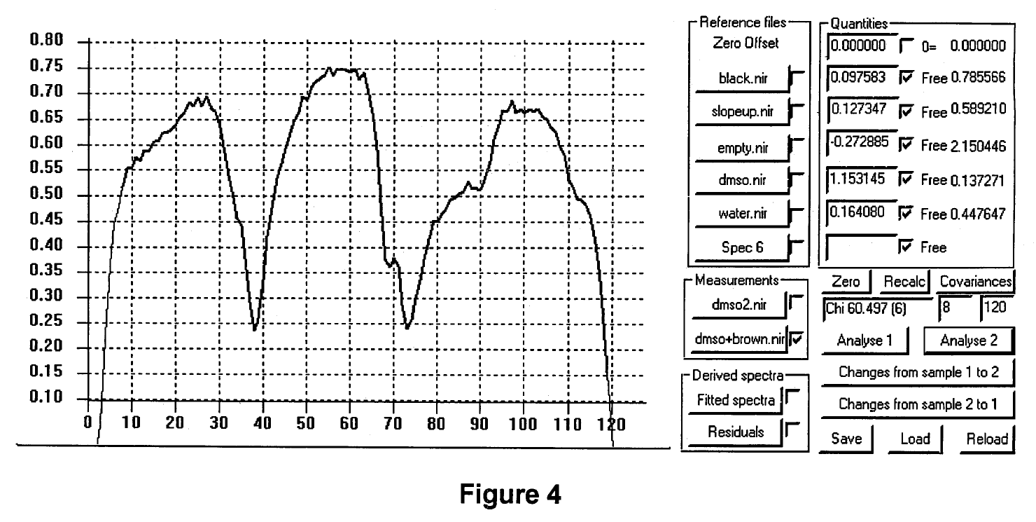

FIG. 4 shows an apparently similar spectrum obtained from a microtube. In this case an impurity has been imitated by passing the light through a sheet of plastic. Although the microtube still contains DMSO the ChiSquared value, obtained when the spectrum from the microtube is compared with the reference spectrum for DMSO, is very high, suggesting that there is something else present as well as the DMSO.

If, for example, it is suspected that the sample is contaminated by water, it is possible to compare the reference data for water and for the previously measured contents of the microtube and examine the best fit line with error statistics. If the ChiSquared value is low then the identification of the contaminant as water is likely to be accurate. If the ChiSquared value is high then the identification has been incorrectly, or incompletely, made. The ChiSquared value is combined with the individual values to give an output ranging from 1 to 10 where less than 1 indicates an excellent fit, values around 5 are a poor fit and values around 10 are no fit.

Although the system has been designed with transmission spectra in mind if the substances are opaque, as is frequently the case with emulsions, then reflection spectra could be used instead.

1. An infra-red analysis system for analysing samples disposed in transparent or translucent containers, the system comprising:
an infra-red light source;
a container locating device for locating a container in a known position relative to the infra-red light source,
a spectrometer disposed to receive infra-red light from the containers, means for reading the identity of a container,
means for transmitting spectra recorded by the spectrometer to a database,
means for recording the spectra and the identity of the container in the database in a record; and
means for comparing spectra recorded by the spectrometer with a previously recorded spectrum for the same container.

2. An infra-red analysis system according to claim 1, wherein the container locating device causes the tube to be rotated while maintaining its position relative to the infra-red light source.

3. An infra-red analysis system according to claim 1 or claim 2, wherein the container is a microtube.

4. An infra-red system according to claim 1 or claim 2, wherein the container is a culture plate.

5. An infra-red system according to claim 1, wherein the spectrometer is disposed to receive light transmitted by the container.

6. An infra-red system according to claim 1, wherein the spectrometer is disposed to receive light reflected by the container.
